(19) United States
(12) Patent Application Publication
(10) Pub. No.: US 2015/0344768 A1
(43) Pub. Date: Dec. 3, 2015

(54) CLARIFYING AND STABILIZING COMPOSITION

(71) Applicant: Aicardo Roa-Espinosa, Madison, WI (US)

(72) Inventor: Aicardo Roa-Espinosa, Madison, WI (US)

(21) Appl. No.: 14/824,541

(22) Filed: Aug. 12, 2015

Related U.S. Application Data
(63) Continuation-in-part of application No. 13/276,848, filed on Oct. 19, 2011, now abandoned.

(51) Int. Cl. C09K 8/584

(52) U.S. Cl. CPC C09K 8/584

(57) ABSTRACT

An aqueous composition, a solid composition and method for producing the solid composition are disclosed. The aqueous and solid compositions may be used in a number of applications such as in processes to recover oil from a production well containing an oil slug and in processes to clarify aqueous slurries containing sedimentation. The compositions comprise a surfactant, a pre-gelatinized starch, an inorganic salt, an oil and a polymer. The method of manufacturing the solid composition includes exposing the aqueous composition to temperatures around 0 degrees F. A solid block stable at ambient temperatures is formed along with a liquid phase that may be separated from the solid block. Dispersing the solid composition in water further enhances flow stability.

### FIELD OF THE INVENTION

The present invention generally relates to a composition useful for modifying the physical properties of water based fluids such as viscosity, density and surface tension. More specifically, embodiments for an aqueous composition, a solid composition and a process for manufacturing the solid composition are provided. The addition of this composition to aqueous based fluids provides stable dispersions that improve the flow properties and enhances the speed of removal of various contaminants. The composition of the present invention can, for example, increase the viscosity and surface tension of aqueous based fluids thereby reducing the interface distortions between two fluids having disparate properties, such as water and oil, under flow conditions. As such, the present invention composition may be used to stabilize fluids employed in the recovery of oil from secondary oil wells and in removing sedimentation from water.

### BACKGROUND OF THE INVENTION

In an embodiment of the present invention, the composition of the present invention may be utilized in the process of oil recovery from secondary oil wells to modify the viscous and surface tension properties of the interface fluid between the driving fluid and the oil.

In a typical secondary oil recovery, a driving fluid, typically water, is pumped into the well which pushes the oil out through an exit pipe. Due to interface distortions between the water and oil phases during flow, large amounts of water become intermixed with the oil when it is pumped out of the well. It would therefore be desirable to find ways to keep the oil as a separate phase when driving it out of the well in order to keep intermixing with the water to a minimum.

Compositions comprising various polymers are cited in prior art references as useful in oil recovery applications from secondary wells.

U.S. Pat. No. 5,529,124 describes a method for retarding the effect of water coning during the production of oil from a subterranean formation. The retarding occurs by injecting into the subterranean formation, at or below the oil/water interface, a polymer solution having a viscosity at least twice that of the connate water to form a zone of high viscosity about the wellbore during the oil production.

U.S. Pat. No. 6,359,040 relates to aqueous compositions of a polymer having a net ionic charge, and a viscosity promoter having an opposite net ionic charge. The compositions may also comprise a moderating agent to prevent precipitation and/or gelation.

U.S. Pat. No. 7,188,673 discloses a process for reducing the production of water in oil wells which comprises the injection of an aqueous solution of a cationic polymer into the formation.

The composition of the present invention provides improved performance compared to the formulations provided in the prior art references and results higher overall recovery of the secondary oil from wells as well as reducing the amount of water intermixed with the oil. None of the prior art references teaches the composition of the present invention.

### SUMMARY OF THE PRESENT INVENTION

The composition of the present invention may be beneficially used in applications including but not limited to: oil recovery from secondary oil wells, reducing soil erosion, as a fertilizing additive and removing sediment from water.

In one aspect of the present invention, an aqueous composition for clarifying and stabilizing fluids comprises: at least one pre-gelatinized starch; at least one inorganic salt having a cationic component and an anionic component; at least one surfactant; and an aqueous emulsion containing at least one oil and at least one polymer.

In another aspect of the present invention, a solid composition for clarifying and stabilizing fluids comprises: at least one surfactant; at least one oil; and at least one polymer.

In yet another aspect of the present invention, a method for manufacturing the solid composition comprises: blending 9.5 mole ethoxylated nonylphenol surfactant with mineral oil in an amount such that a proportion of the 9.5 mole ethoxylated nonylphenol surfactant in the solid composition ranges from about 1.0 percent to about 10.0 percent by weight of the total solid composition and such that a proportion of the mineral oil in the solid composition ranges from about 1.0 percent to about 10.0 percent by weight of the total solid composition to form an intermediate blend; applying vigorous mixing to the intermediate blend to achieve a uniform dispersion of the intermediate blend; blending with the intermediate blend an amount of a mixture of polymer and water in about an equal proportion, such that a proportion of the polymer in the solid composition ranges from about 67.0 percent to about 90.0 percent by weight of the total solid composition to form a final blend; exposing the final blend to a temperature in the range of about −10° F. to +10° F. for a sufficient time period to form a solid phase and a liquid phase with the solid phase forming a solid block; and separating the liquid phase from the solid phase with the liquid phase containing oil and water.

These and other features, aspects and advantages of the present invention will become better understood with reference to the following description and claims.

### DETAILED DESCRIPTION OF THE INVENTION

The aqueous composition of the present invention comprises at least one starch, at least one surfactant, at least an inorganic salt containing a cation and an anion, and an aqueous emulsion containing at least one oil and at least one polymer.

The preferred embodiment for the surfactant is 9.5 mole ethoxylated nonylphenol surfactant. As one example, a product currently on the market suitable for this application is SURFONIC® N-95 Surfactant.

The preferred starch is pre-gelatinized manufactured by cooking raw starch then drying it to ambient moisture. A variety of starches fall within the scope of the present invention including but not limited to corn, potato, rice, tapioca and wheat. The starch may have an anionic, cationic or neutral charge. In an embodiment of the present invention, a component of the starch used in the composition is amylose made of between about 300 and about 3000 repeat D-glucose units having a formula as shown below.

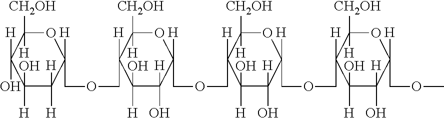

The salt may comprise of any combination of sodium, potassium, calcium or magnesium cations, with nitrate, sulfate, chloride and hypochlorite anions.

The preferred oil component in the emulsion is mineral oil having a formula CₙH₂ₙ₊₂ where n ranges from 6-18.

A preferred embodiment of the present invention for the polymer is anionic polyacrylamide. An example is Sodium Acrylate Acrylamide copolymer resulting from the reaction between an Acrylamide monomer and an Acrylic Acid monomer as shown below. Another example is Potassium Acrylate Acrylamide copolymer. However, suitable polyacrylamide polymers for use with the emulsion of the present invention include cationic as well as non-ionic polyacrylamides.

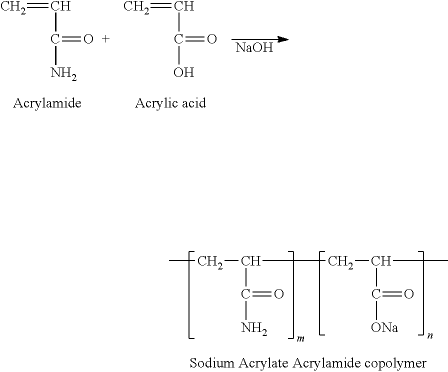

Other suitable polymer components for the emulsion may comprise of polyamines. Examples of suitable polyamines include, but are not limited to, diallyldimethyl-ammonium chloride (DADMAC) or poly-diallyldimethyl-ammonium chloride (Poly-DADMAC), a cationic branched polyamine that is a product of the reaction between dimethylamine and allyl chloride. Diallyldimethyl-ammonium chloride and poly-diallyldimethyl-ammonium chloride are produced by the reaction shown below, but diallyldimethyl-ammonium chloride is made under conditions that inhibit polymerization while the poly-diallyldimethyl-ammonium chloride is made under conditions that promote polymerization. The molecular weight of the poly-diallyldimethyl-ammonium chloride is ideally between about 10,000 and 1,000,000.

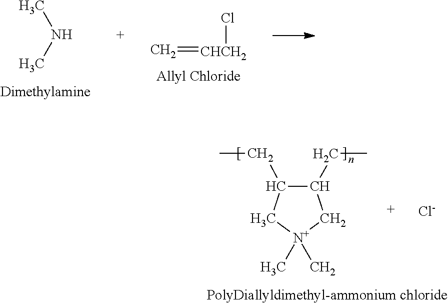

The desired ranges for the components of the solution are as follows:

| Component | Content |
|---|---|
| Surfactant | about 1.0 percent to about 3.0 percent by weight of the |
| | total composition |
| Salt | about 0.1 percent to about 10.0 percent by weight of the |
| | total composition |
| Starch | about 0.1 percent to about 29.0 percent by weight of the |
| | total composition |
| Emulsion | about 67.0 percent to about 98.8 percent by weight of the |
| | total composition |
| Polymer | about 30.0 percent to about 35.0 percent by weight of the |
| | total emulsion composition |
| Oil | about 30.0 percent to about 35.0 percent by weight of the |
| | total emulsion composition |
| Water | about 30.0 percent to about 35.0 percent by weight of the |
| | total emulsion composition |

An important aspect of the effective utilizing the composition is the colloidal stability of the stabilizing fluid when used in large quantities and under flow and shear conditions. In an embodiment of the present invention, a solid composition comprising a surfactant, a salt, a pre-gelatinized starch, a polymer, an oil and a small amount of ambient moisture provides a number of advantages for enhancing the flow stability of fluids. The solid composition, which may come in the form of a solid block, flakes or ground particles, is cheaper to transport and has a significantly lower propensity to settle out than the aqueous composition when dispersed in water. The solid composition may comprise of the following ingredients and their respective percentage ranges in the solid composition:

The desired ranges for the components of the solution are as follows:

| Component | Content |
|---|---|
| Surfactant | about 1.0 percent to about 10.0 percent by weight of the |
| | total composition |
| Salt | about 0.5 percent to about 25.0 percent by weight of the |
| | total composition |
| Starch | about 1.0 percent to about 28.0 percent by weight of the |
| | total composition |
| Polymer | about 67.0 percent to about 90.0 percent by weight of the |
| | total composition |
| Oil | about 1.0 percent to about 10.0 percent by weight of the |
| | total composition |
| Water | about 1.0 percent ambient moisture |

In an embodiment of the present invention, the manufacturing of the solid composition is accomplished by subjecting an aqueous emulsion as previously disclosed to low temperatures for sufficient time periods to produce a solid phase and a liquid phase. The liquid phase generally contains a mixture of oil and water and smaller amounts of the other ingredients. The liquid phase is physically separated from the solid phase, such as by means of decanting. The resulting composition after the liquid phase is separated from the solid phase is as provided in the table above. The solid phase is generally stable and maintains its solid state at room temperature.

The solid phase may be further processed into a more useable form such as grinding into smaller particles, typically in the range of about 0.2 mm to about 2 mm, or compressed into tablets. The particles or tablets quickly dissolve in water to form a stable dispersion suitable for use in the various aforementioned applications. The oil in the liquid phase may be separated from the water and reused.

In other embodiments of the present invention, the pre-gelatinized starch, the salt or both may be absent from the solid composition. The ingredients for these compositions and the percentage ranges of the ingredients in the composition are shown in the following tables:

TABLE
Alternate solid composition embodiment 1.

| Component | Content |
|---|---|
| Surfactant | about 1.0 percent to about 10.0 percent by weight of the |
| | total composition |
| Polymer | about 67.0 percent to about 90.0 percent by weight of the |
| | total composition |
| Oil | about 1.0 percent to about 10.0 percent by weight of the |
| | total composition |
| Water | about 1.0 percent ambient moisture |

TABLE
Alternate solid composition embodiment 2.

| Component | Content |
|---|---|
| Surfactant | about 1.0 percent to about 10.0 percent by weight of the |
| | total composition |
| Starch | about 1.0 percent to about 28.0 percent by weight of the |
| | total composition |
| Polymer | about 67.0 percent to about 90.0 percent by weight of the |
| | total composition |
| Oil | about 1.0 percent to about 10.0 percent by weight of the |
| | total composition |
| Water | about 1.0 percent ambient moisture |

The steps of the method for forming the solid composition comprise of:

1. Blending amounts of mineral oil and 9.5 mole ethoxylated nonylphenol surfactant such that their target percent contents in the final solid composition falls within the desired range. This should be followed by vigorous mixing to achieve a uniform dispersion.

2. Blending in a predetermined amount of a mixture of the polymer and water in about an equal proportion such that a proportion of the polymer in the solid composition ranges from about 20.0 percent to about 35.0 percent by weight of the total solid composition to form a final blend. The polymer is preferably an anionic polyacrylamide such as Sodium Acrylate Acrylamide copolymer. Alternatively, the polymer may be Potassium Acrylate Acrylamide copolymer.

3. Exposing the final blend to a temperature in the range of about −10° F. to +10° F. for a sufficient time period to form a solid phase forming a solid block, and a liquid phase;

4. Removing the liquid phase for reprocessing; and

5. Grinding the solid block into particles ranging from an average diameter of about 0.2 mm to about 2 mm.

6. Pressing out a solid segment of predetermined size and shape to be utilized in end use processes. These segments may be tablet size, but larger sizes also fall within the scope of the present invention.

The process may additionally comprise:

7. Blending with the intermediate blend an amount of pre-gelatinized starch such that a proportion of the starch in the solid composition falls within the desired range, and

8. Blending with the intermediate blend an amount of salt such that a proportion of the salt in the solid composition falls within the desired range. The cationic component of the inorganic salt is preferably selected from the group consisting of sodium, potassium, calcium, magnesium, and combinations thereof, and the anionic component of the salt is preferably selected from the group consisting of nitrate, sulfate, chloride, hypochlorite and combinations thereof.

The time required to form the solid block from the final blend may vary from about 3 to about 11 hours depending on the temperature. Likewise, the resulting consistency, hardness and density of the solid composition may vary depending on the temperature and time of exposure. A soft block may not grind well and thus would need to be used as is in the applications.

The difference between freeze-drying of polymers, which is well known in the art, method of the present invention is noteworthy. The method of the present invention does not require a specific drying step. While some of the water naturally evaporates naturally during the period of exposing the final blend to the process temperature, most of the water and oil rise to the top of the formed solid block. The remaining water and oil in the solid block is typically relatively low.

We claim:

1. An aqueous composition for clarifying and stabilizing fluids, and for stabilizing soil systems comprising:
at least one pre-gelatinized starch;
at least one inorganic salt having a cationic component and an anionic component;
at least one surfactant; and
an aqueous emulsion containing at least one oil and at least one polymer.

2. The composition of claim 1, wherein the surfactant comprises a 9.5 mole ethoxylated nonylphenol surfactant.

3. The composition of claim 1, wherein the cation of the salt is selected from the group consisting of sodium, potassium, calcium, magnesium, and combinations thereof, and the salt anion is selected from the group consisting of nitrate, sulfate, chloride, hypochlorite and combinations thereof.

4. The composition of claim 1, wherein:
the inorganic salt is present in a proportion ranging from about 0.1 percent to about 10.0 percent by weight of the total composition;
the starch is present in a proportion ranging from about 0.1 percent to about 29 percent by weight of the total composition;
the surfactant present in a proportion ranging from about 1 percent to about 3 percent by weight of the total composition; and
the emulsion is present in a proportion ranging from about 67 percent to about 98.8 percent by weight of the total composition.

5. The composition of claim 1, wherein the polymer is present in the emulsion in a proportion ranging from about 30 percent to about 35 percent by weight of the total emulsion composition, water is present in the emulsion in a proportion ranging from about 30 percent to about 35 percent by weight of the total emulsion composition and the oil is present in a proportion ranging from about 30 percent to about 35 percent by weight of the total emulsion composition.

6. The composition of claim 1, wherein the polymer is selected from the group consisting of polyacrylamides, polyacrylamide copolymers, polyamines and combinations thereof.

7. The composition of claim 1, wherein the polymer is Polydiallyldimethylammonium chloride.

8. The composition of claim 1, wherein the polymer is selected from the group consisting of Sodium Acrylate Acrylamide copolymer and Potassium Acrylate Acrylamide copolymer.

9. The composition of claim 1, wherein the oil comprises mineral oil.

10. The composition of claim 9, wherein a molecule of the mineral oil comprises between about 6 carbons to about 18 carbons.

11. A solid composition comprising:
at least one surfactant;
at least one oil; and
at least one polymer.

12. The solid composition of claim 11 further comprising at least one pre-gelatinized starch.

13. The solid composition of claim 12 further comprising at least one inorganic salt having a cationic component and an anionic component, wherein the cationic component of the salt is selected from the group consisting of sodium, potassium, calcium, magnesium and combinations thereof, and the anionic component of the salt is selected from the group consisting of nitrate, sulfate, chloride, hypochlorite and combinations thereof.

14. The solid composition of claim 11, wherein the surfactant comprises 9.5 mole ethoxylated nonylphenol surfactant.

15. The solid composition of claim 11, wherein the polymer is selected from the group consisting of polyacrylamides, polyacrylamide copolymers, polyamines and combinations thereof.

16. The composition of claim 11, wherein the polymer is Polydiallyldimethylammonium chloride.

17. The composition of claim 11, wherein the polymer is selected from the group consisting of Sodium Acrylate Acrylamide copolymer and Potassium Acrylate Acrylamide copolymer.

18. The solid composition of claim 11, wherein the oil comprises mineral oil.

19. The solid composition of claim 13, wherein:
the salt is present in a proportion ranging from about 0.5 percent to about 25.0 percent by weight of the total composition;
the starch is present in a proportion ranging from about 1.0 percent to about 28.0 percent by weight of the total composition;
the surfactant is present in a proportion ranging from about 1.0 percent to about 10.0 percent by weight of the total composition;
the polymer is present in a proportion ranging from about 67.0 percent to about 90.0 percent by weight of the total composition; and
the mineral oil is present in a proportion ranging from about 1.0 percent to about 10.0 percent by weight of the total composition.

20. A method for manufacturing the solid composition of claim 15, said method comprising:
blending 9.5 mole ethoxylated nonylphenol surfactant acid with mineral oil in an amount such that a proportion of the 9.5 mole ethoxylated nonylphenol surfactant in the solid composition ranges from about 1.0 percent to about 10.0 percent by weight of the total solid composition and such that a proportion of the mineral oil in the solid composition ranges from about 1.0 percent to about 10.0 percent by weight of the total solid composition to form an intermediate blend;
applying mixing to said intermediate blend to achieve a uniform dispersion of the intermediate blend;
blending with the intermediate blend an amount of a mixture of polymer and water in about an equal proportion, such that a proportion of the polymer in the solid composition ranges from about 67.0 percent to about 90.0 percent by weight of the total solid composition to form a final blend;
exposing the final blend to a temperature in the range of about −10° F. to +10° F. for a sufficient time period to form a solid phase and a liquid phase, said solid phase forming a solid block wherein said liquid phase consists of oil and water and forms on top of the solid phase; and
separating the liquid phase from the solid phase.

21. The method of claim 20 further comprising grinding the solid block into particles having an average size of between about 0.2 millimeters to about 2 millimeters.

22. The method of claim 20, further comprising subdividing said solid block into portions of suitable sizes for specific uses and compressing said portions into tablet form.

23. The method of claim 20, further comprising blending with the intermediate blend an amount of pre-gelatinized starch such that a proportion of the pre-gelatinized starch in the solid composition ranges from about 1.0 percent to about 28.0 percent by weight of the total solid composition.

24. The method of claim 23, further comprising mixing with the intermediate blend an amount of inorganic salt such that a proportion of the inorganic salt in the solid composition ranges from about 0.5 percent to about 25.0 percent by weight of the total solid composition, said inorganic salt having a cationic component and an anionic component wherein the cationic component of the salt is selected from the group consisting of sodium, potassium, calcium, magnesium and combinations thereof, and the anionic component of the salt is selected from the group consisting of nitrate, sulfate, chloride, hypochlorite and combinations thereof.
